(19) United States
(12) Patent Application Publication
(10) Pub. No.: US 2026/0095247 A1
(43) Pub. Date: Apr. 2, 2026

(54) ENHANCING NETWORK RESILIENCY AND PERFORMANCE THROUGH MULTIPATH ROUTING WITH METASURFACE-INTEGRATED PORTABLE TRANSCODER

(71) Applicant: Dell Products L.P., Round Rock, TX (US)

(72) Inventors: Navjot Kaur Khaira, Manotick (CA); Tejinder Singh, Manotick (CA); Michael J. Healy, Scituate, MA (US)

(21) Appl. No.: 18/902,395

(22) Filed: Sep. 30, 2024

(51) Int. Cl. H04B 7/185

(52) U.S. Cl. CPC H04B 7/18517

(57) ABSTRACT

The technology described herein is directed towards a transcoder device (node) that leverages multipath routing techniques using both terrestrial and satellite links simultaneously. The transcoder device implements the multipath transmission control protocol (MPTCP) along with metasurfaces, such as to support satellite, ethernet, Wi-Fi, and new radio (e.g., 5G) interfaces. The transcoder can decode and reencode data packets at the packet level to facilitate communication between user equipment (UEs) and existing Satcom satellites. A metasurface redirects signals from the satellite to a satellite radio frequency (RF) interface of the transcoder, with the transcoder also coupled by a UE RF interface to a UE, such as a computing device or cellphone. For direct-to-device communications, transcoder conversion is bypassed. Various additional functions facilitate such satellite service, including via frequency conversion, doppler manipulation, a repeater, and frequency equalization/negative-slope compensation.

### RELATED APPLICATION

The subject patent application is related to U.S. patent application Ser. No. 18/780,254, filed Jul. 22, 2024, and entitled “TRANSCODING THE AIR-INTERFACE BETWEEN NON-TERRESTRIAL AND TERRESTRIAL NETWORKS LEVERAGING INTEGRATED METASURFACES” (docket no. 139018.01/DELLP1230US), the entirety of which patent application is hereby incorporated by reference herein.

### BACKGROUND

Non-terrestrial network communications are defined as part of fifth generation (5G) communications in current third generation partnership project (3GPP) standards. However, the reliability of non-terrestrial network satellite direct-to-device service is problematic, especially when a user equipment (UE) moves to an indoor environment, due to various radio frequency signal attenuations introduced by a roof, wall, or other physical structures that are between a satellite and the UE. As such, present satellite communication (non-terrestrial network) services basically require a line-of-sight (LoS) path between a satellite and a user equipment device to reduce radio frequency signal fading or shadowing in order to provide reliable communication.

Further, the air-interfaces of satellite communications (Satcom, sometimes “SatCom” and other times “SATCOM”) and those used for terrestrial mobile wireless (5G, LTE and the like) have significant differences, including having to comply with different standards from one another. Traditional non-terrestrial routing techniques often suffer from issues related to network congestion, link failures, and varying signal conditions, leading to unreliable connectivity.

### BRIEF DESCRIPTION OF THE DRAWINGS

The technology described herein is illustrated by way of example and not limited by the accompanying figures in which like reference numerals indicate similar elements and in which:

FIG. 1 is a block diagram of a system/architecture of a transcoder device that supports multipath routing, in accordance with various example embodiments and implementations of the subject disclosure.

FIG. 2 is a sequence diagram representing example operations related to real-time adaptation of signal quality between a UE and a transcoder device, in accordance with various example embodiments and implementations of the subject disclosure.

FIG. 3 is a block diagram showing an example hardware-based transcoder device in which radio frequency (RF) downlink and uplink signals are connected for RF input and output, in accordance with various example embodiments and implementations of the subject disclosure.

FIG. 4 is a block diagram showing an example L1-PHY module/component of a transcoder device, with bypass capability, and with an edge compute device, in accordance with various example embodiments and implementations of the subject disclosure.

FIG. 5 is a representation of multiple example locations for deploying a metasurface (reconfigurable intelligent surface, or RIS) indoors, including metasurfaces configured to operate in a transmission mode and reflection mode, in accordance with various example embodiments and implementations of the subject disclosure.

FIGS. 6A and 6B are representations of example metasurfaces configured to operate in a transmission mode and reflection mode, respectively, in accordance with various example embodiments and implementations of the subject disclosure.

FIG. 7 is an example top view representation of an example metasurface panel that can be configured to operate in a transmission mode or a reflection mode, in accordance with various example embodiments and implementations of the subject disclosure.

FIG. 8 is an example top view representation of an example unit-cell suitable for use in a metasurface that operates in a transmission mode or a reflection mode, in accordance with various example embodiments and implementations of the subject disclosure.

FIG. 9 is a flow diagram showing example operations related to obtaining transport connection data representative of one or more multipath transmission control protocol (MPTCP) data paths for a data transmission of network data based on the transport connection data, in accordance with various example embodiments and implementations of the subject disclosure.

FIG. 10 is a flow diagram showing example operations related to obtaining transport connection data representative of a group of MPTCP data paths, adjusting a metasurface based on the transport connection data, and transmitting network data via the metasurface, in accordance with various example embodiments and implementations of the subject disclosure.

### DETAILED DESCRIPTION

The technology described herein is generally directed towards a transcoder device (node) that leverages multipath routing techniques using both terrestrial and satellite links simultaneously. Terrestrial links include Wi-Fi, fifth generation new radio (5G NR), and ethernet; satellite links include satellite communication (Satcom) and direct-to-device (D2D). By implementing multipath transmission control protocol (MPTCP) along with metasurface technologies, the system enhances redundancy, load balancing, and overall network reliability. Such a hybrid connectivity approach ensures continuous connectivity and more optimal performance, even under varying network conditions.

The technology described herein is particularly beneficial for hybrid internet service providers aiming to deliver cost-effective and reliable broadband services in remote and rural regions. This in part is because traditional single-path routing techniques often suffer from issues related to network congestion, link failures, and varying signal conditions, leading to unreliable internet connectivity. In remote and rural areas, the lack of extensive terrestrial infrastructure further exacerbates these challenges, making it difficult to provide consistent and high-speed internet services. The technology described herein provides a robust solution that can dynamically adapt to changing network conditions and leverage multiple communication paths to ensure continuous and reliable connectivity. In one implementation, the technology can be incorporated into a transcoder device (e.g., a portable transcoder “box” structure) that integrates multipath routing with metasurface technology, enabling the simultaneous use of terrestrial and satellite links.

With respect to transcoding, the transcoder facilitates connecting user equipment type modems (e.g., 3GPP-compliant 4G/5G commercial off the shelf devices and beyond) to the legacy satellite satcom communication protocol, whereby user equipment (UE) are able to communicate with satellite services. Significantly, via a Layer-1 physical (L1-PHY) transcoder, the technology described herein provides the capability for the UE to communicate with a low earth orbit (LEO) satellite or a terrestrial tower using two different air-interfaces. The two air-interfaces include the DVB-compliant Satcom interface and 3GPP-compliant fifth generation new radio (5G NR) Direct-to-Device (D2D) interface. This dual RF capability allows the L1-PHY transcoder to operate at two different frequency bands, legacy satcom and the newer 3GPP FR1/FR2 bands.

Further, the integration of a metasurface, or reconfigurable intelligent surface (RIS integration) facilitates portability and disaggregation. More particularly, while the indoor radio frequency (RF) signal is converted using the transcoding technology described herein, the indoor RF signal needs to get outdoors to achieve line-of-sight (LoS) connectivity directly to the satellite. RIS technology provides the capability to transmit the indoor RF signal to the outdoor environment, that is, transmit the UE signal from indoors-to-outdoors and outdoors-to-indoors wirelessly, eliminating the need for a physical cable to connect a mounted outdoor antenna to indoor UEs. Among other benefits, a RIS also adds the benefit of portability, and different ways to deploy the transcoder device. For example, the transcoder device can be standalone box, integrated into an antenna, tether-box attached to notebook, and so on. The transcoder device and RIS also can be disaggregated, e.g., to have some components/features in a computing device such as a notebook, and other components/features in an external RIS/antenna.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and metasurfaces in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

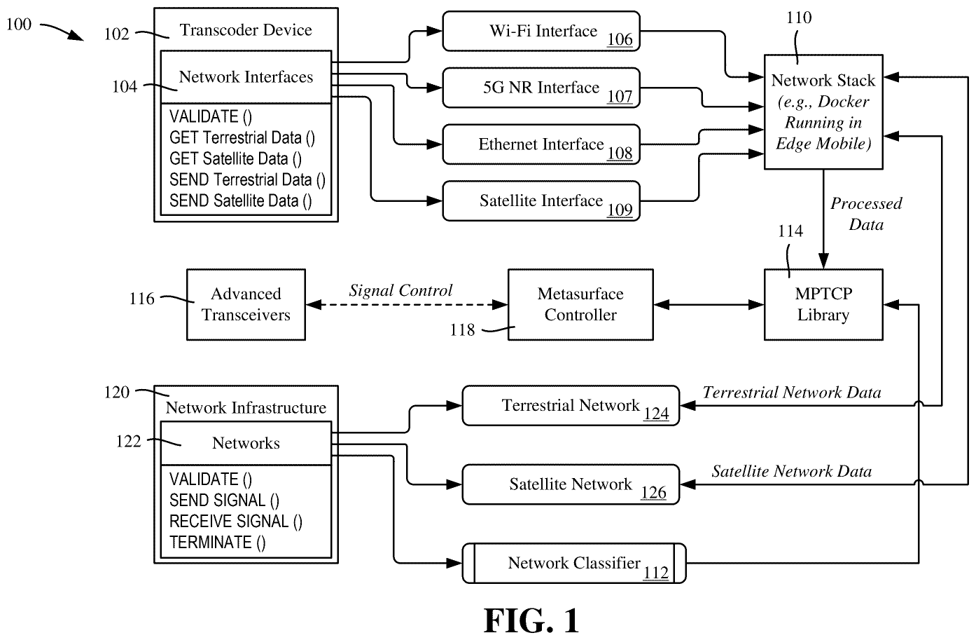

FIG. 1 shows an architecture/system 100 including a transcoder device 102 that includes network interfaces 104 for both terrestrial (e.g., Wi-Fi interface 106, 5G NR interface 107, ethernet interface 108) and non-terrestrial (satellite interface 109) communication, enabling the use of multiple TCP subflows within a single connection. This integration allows data to be transmitted concurrently across multiple network interfaces such as Wi-Fi, cellular, and satellite, significantly improving network resilience and throughput. The system architecture 100 of FIG. 1 shows the transcoder box 102, which, along with the various network interfaces 104, includes a (e.g., Linux®) network stack 110, e.g., running in a docker on an edge compute module with a network classifier 112 attached to the MPTCP library 114. As is known, the MPTCP library 114 includes a number of defined functions and data structures that can be part of the network stack 110, although in alternatives such functions and data structures can be separate from and invoked as needed.

To implement multipath routing, the transcoder box 102 is thus equipped with multiple high-performance network interfaces (collectively 104). The example individual interfaces 106-109 shown in FIG. 1 support Wi-Fi, 5G NR, Ethernet and satellite communication, respectively, ensuring that the transcoder device 102 can connect to a variety of networks simultaneously. As represented in FIG. 1, network infrastructure 120 includes the networks 122, namely at least one terrestrial network 124 and a satellite network 126. Each interface can be equipped with an advanced transceiver (block 116) designed to handle high data rates and maintain robust connectivity under varying conditions. The hardware architecture is optimized to support simultaneous operation of the interfaces 106-109, which is appropriate for leveraging the capabilities of multipath TCP (MPTCP). One implementation employs separate switching connections and transceivers (rather than sharing any transceiver, although sharing is feasible).

In one implementation, the software architecture (including network stack 110) of the transcoder box is built on a Linux®-based operating system, for its flexibility and robust support for networking protocols. Central to this software network stack 110 is the implementation of MPTCP, an extension of the standard TCP protocol. MPTCP allows a single TCP connection to use multiple paths concurrently, improving redundancy and load balancing. The integration of MPTCP involves incorporating a suitable MPTCP library 114 within the network stack 110. The MPTCP library 114 library manages the creation, maintenance, and teardown of multiple TCP subflows, ensuring that data is transmitted efficiently across the available network interfaces.

Dynamic path selection is a feature of MPTCP. The software (network stack 110 including the MPTCP library 114) monitors network conditions, such as latency, bandwidth, and packet loss, to dynamically adjust the use of different paths. Such real-time adaptation ensures that the best available links are utilized at any given moment, maximizing performance, and maintaining continuous connectivity. By abstracting the complexity of multiple paths, MPTCP provides a seamless experience to applications, presenting a single, reliable connection despite the underlying complexity.

The integration of metasurfaces within (or closely coupled to) the transcoder device 102 adds a layer of intelligent signal management facilitating selective amplification and directionality control of signals. A metasurface enhances the device's ability to maintain strong and reliable connections with both terrestrial and satellite networks. The metasurface components are managed by a metasurface controller 118 that adjusts the metasurface properties in real-time based on network conditions, optimizing signal quality and reducing interference. The selective amplification and attenuation are controlled via models, processes or the like that predict signal conditions and adjust metasurface (or multiple metasurface) properties dynamically.

In one implementation, the hardware integrates the transceivers and metasurface controller 118 (or controllers). Concurrently, the software integrates the MPTCP library 114 into the network stack 110. Control (block 118) for the metasurface(s) ensure they can respond to real-time network conditions. The transcoder devices can be implemented as “box” structures deployed in diverse environments, particularly in remote and rural areas where reliable internet connectivity is highly desirable. Performance is continuously monitored, and adjustments are made as necessary to facilitate optimal operation and adaptability to evolving network conditions. The deployment can include collaboration with Hybrid ISPs, enabling them to deliver cost-effective and reliable broadband services without the need for extensive terrestrial infrastructure.

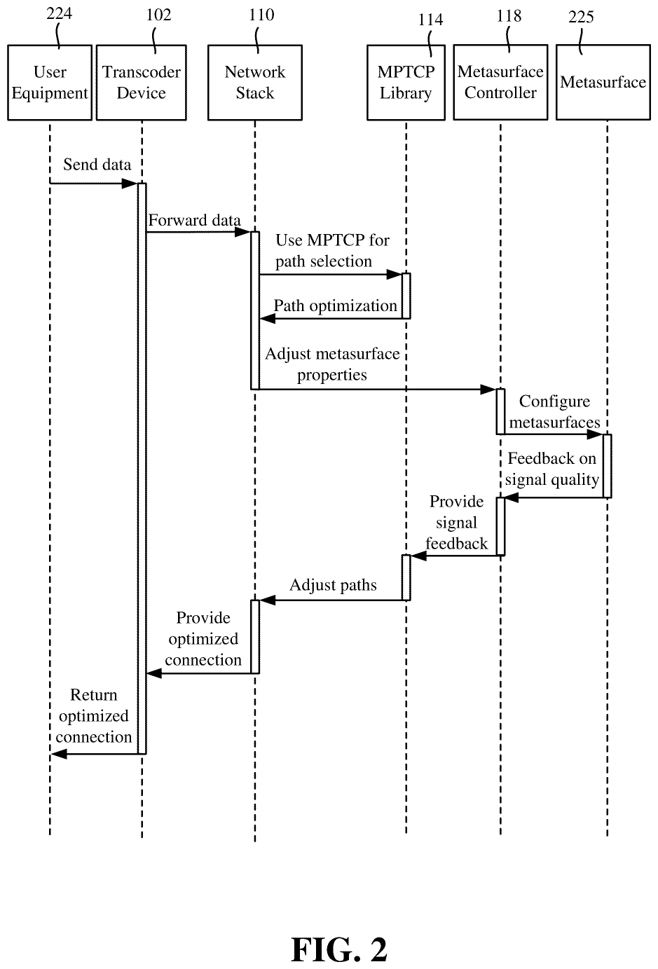

An example real time adaptation sequence diagram is shown in FIG. 2. The sequence diagram outlines a comprehensive example process for optimizing data transmission using a transcoder box 102, network stack 110, MPTCP library 114, metasurface controller 118, and metasurface 225. This detailed interaction begins with the user's input and traverses through multiple components to ensure an optimized and reliable network connection.

Initially, user equipment 224 initiates the process by sending data to the transcoder device 102. This transcoder device 102, designed to handle and process incoming data, acts as the primary interface between the user equipment 224 and the network infrastructure 120 (FIG. 1). Once the data is received, the transcoder device 102 forwards it to the network stack 110. The network stack 110 is responsible for managing network protocols and facilitating communication between devices. Here, the network stack 110 utilizes the MPTCP library 114, which selects the optimal paths for data transmission. The MPTCP library 114 allows the network stack to leverage multiple paths concurrently, enhancing redundancy, load balancing, and overall network reliability.

After the MPTCP library 114 determines the optimal path or paths, the MPTCP library 114 sends the path optimization information, as transport connection data that represents the path(s), back to the network stack 114. The network stack 110, now equipped with the best routes for data transmission, communicates with the metasurface controller 118 to adjust the properties of the metasurface 225 accordingly. The metasurface controller 118 configures the metasurface(s) to optimize signal propagation and improve communication quality. This configuration involves fine-tuning the metasurface properties to enhance signal strength and directionality.

The metasurface 225, now configured, provides feedback on signal quality to the metasurface controller 118, and in turn to the MPTCP library 114. This feedback loop ensures that any changes in the signal environment are promptly addressed, allowing for real-time adjustments. Thus, the metasurface controller 118 relays the signal quality information back to the MPTCP library 114, which uses the signal quality information to further refine the path optimization process. This continuous feedback mechanism ensures that the data transmission paths remain optimal under varying conditions.

Subsequently, the MPTCP library can adjust the network paths based on the feedback received, ensuring that the data transmission remains efficient and reliable. The network stack 110 provides the optimized connection information to the transcoder device 102. In turn, the transcoder box 102, having received the optimized connection details, returns the optimized connection to the user equipment 224, completing the process. This optimized connection ensures that the user of the user equipment 224 experiences improved network performance, with enhanced data transmission reliability and efficiency.

To summarize, the technology described herein significantly increases the available bandwidth and throughput by leveraging multiple communication paths to the extent possible and available, leading to faster data transfer rates. The use of MPTCP ensures that connectivity is maintained even if one path fails or becomes congested, thereby providing higher reliability and fault tolerance. This hybrid connectivity approach is especially advantageous for Hybrid ISPs, enabling them to deliver cost-effective and reliable broadband services in areas lacking extensive terrestrial infrastructure. Additionally, the integration of metasurfaces enhances the system's ability to manage signal amplification and directionality, further improving network performance. The flexibility and scalability of the proposed transcoder device, e.g., in a box structure, make it well-suited for future network advancements, facilitating long-term viability in the ever-evolving technological landscape.

To this end, hybrid multipath routing in terrestrial networks and non-terrestrial networks is facilitated by what can be a connected portable transcoder box. The technology described herein combines MPTCP with metasurface technology for dynamic data routing across ethernet, Wi-Fi, 5G NR, and satellite interfaces, enhancing connectivity and performance. Further, the dynamic real-time network adaptation based on continuously/regularly monitoring conditions and adjusting paths in real-time using MPTCP ensures high data transfer rates and minimal disruptions. The integration of metasurfaces for signal level adjustment can achieve seamless connectivity with various terrestrial and non-networks from outside networks, and various interfaces for indoor networks. Note that a single metasurface can be subdivided into different sections for different purposes, e.g., one can be directed for satellite communication, and another for local communication. By leveraging multiple paths, MPTCP can significantly increase the available bandwidth and throughput, leading to faster data transfer rates, and at the same time, the use of multiple paths ensures that if one path fails or becomes congested, others can maintain the connection, providing higher reliability and fault tolerance.

Turning to satellites in general, satellite communications (satcom) have long been commercialized to provide mobile (aviation, sea, railroad), fixed (isolated rural area), and broadcast services for decades, while the terrestrial network has gone through 2G, 3G, 4G and 5G evolutions. With 3GPP now adding non-terrestrial networks (NTN) in the standards definition of 5G, satellite direct-to-device is likely to be used with smartphones, sensors, laptops and connected vehicles, wherever stable connectivity can be assured between such user equipment and a satellite. Indeed, 3GPP NR-non-terrestrial network standards enable non-terrestrial network direct-to-everything services, by defining a high-level architecture that is compatible with most mobile handsets and internet-of-things (IoT) devices, as well as defining the operating bands in FR1 for UE to transmit and receive data with a satellite. The following table 1 shows the satellite operating bands in FR1 as defined by 3GPP Release 17:

TABLE 1

| | Uplink (UL) | Downlink (DL) | |
|---|---|---|---|
| Satellite | operating band SAN | operating band SAN | |
| operating | receive/UE transmit | transmit/UE receive | Duplex |
| band | F_{UL, low}-F_{UL, high} | F_{DL, low}-F_{DL, high} | mode |
| n255 | 1626.5 MHz-1660.5 MHz | 1525 MHz-1559 MHz | FDD |
| n256 | 1980 MHz-2010 MHz | 2170 MHz-2200 MHz | FDD |

Note that 3GPP is currently considering new radio (NR)-non-terrestrial networks above 10 GHz in the FR2 band. The Ka-band is the highest-priority band with uplinks between 17.7 and 20.2 GHz and downlinks between 27.5 and 30 GHz, based on ITU (International Telecommunication Union) information regarding satellite communications frequency use. It is expected that FR2 band will be standardized in the future 3GPP releases.

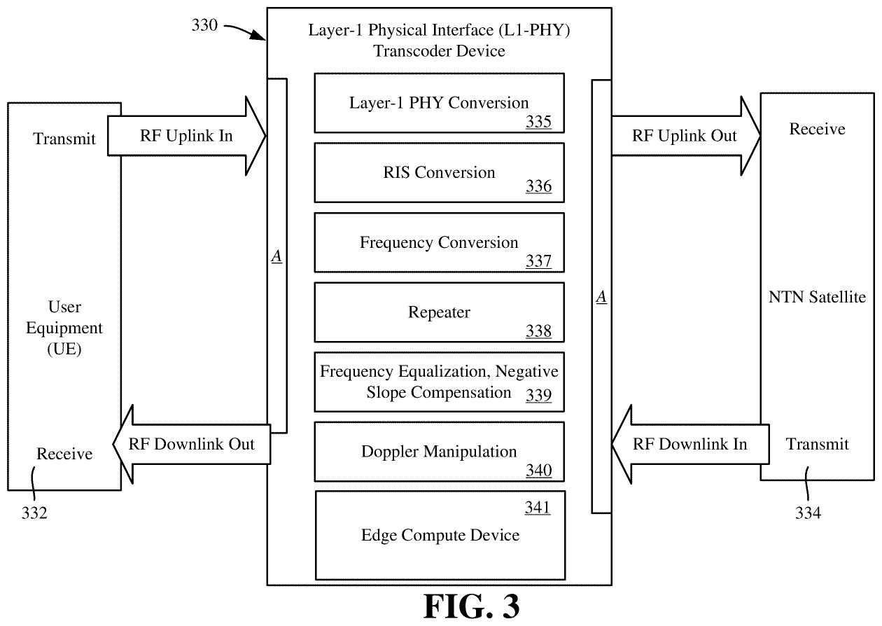

In one or more example implementations, as shown in FIG. 3, described herein is a transcoder device 330 (e.g., in the structure of a “box”) that couples a user equipment 332 to a non-terrestrial network (NTN) satellite 334 with respect to RF uplink signals from the user equipment 332 to the satellite 334, and RF downlink signals from the satellite 334 to the user equipment 332. Various types of user equipment can include, but are not limited to, personal (e.g., notebook/laptop) computers, other computing devices, cellphones, wireless-tether-boxes, fixed wireless access (FWA)-boxes, and IoT/NB-IoT (internet of things/narrowband-internet of things) devices.

As shown in FIG. 3, a number of hardware and/or software-based modules/components 335-341 perform various functions related to the transcoding of RF input to RF output, in both uplink and downlink directions, according to the input protocols, formatting, and so forth, in the appropriate output format for the receiving entity. Note that such transcoding is not needed for the new radio non-terrestrial networks, e.g., using FR1 and FR2 bands as described herein. While these modules as described herein are shown separated in one example implementation, this is only one non-limiting example, and the various functionality performed thereby can be divided among more modules, and/or at least some of the example modules can be combined together to perform the transcoding-related functionality as described herein.

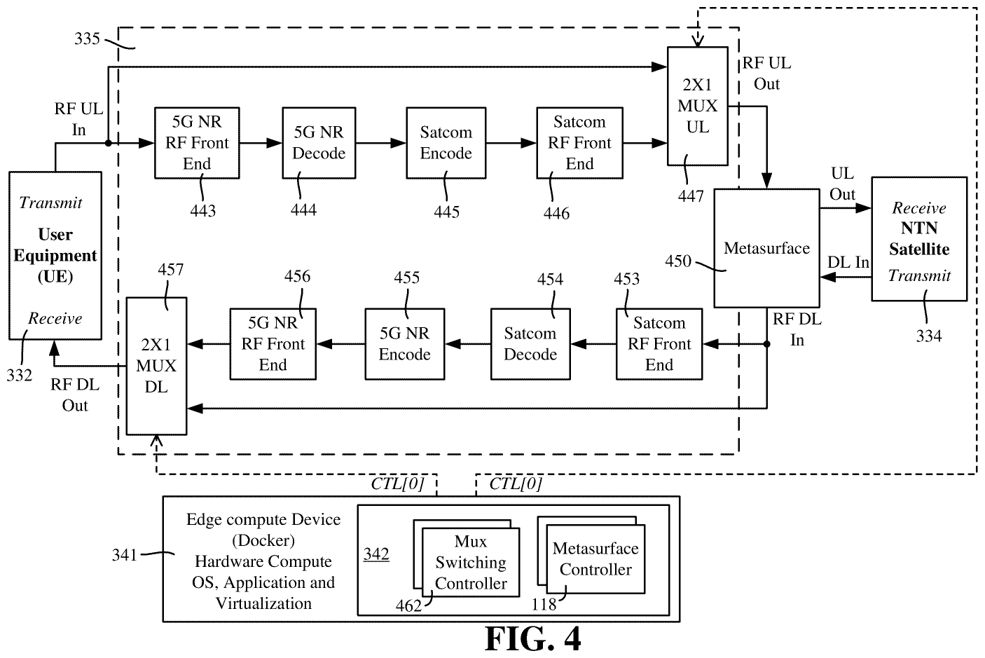

In the example of FIG. 3, when transcoding (5G to or from Satcom) is appropriate, a layer-1 physical interface (L1-PHY) transcoder conversion device 335, with bypass capability, performs L1-PHY gate-level packet-level conversion. As shown in more detail in FIG. 4, L1-PHY gate-level packet-level conversion is performed in the UE uplink direction, from the RF front-end control interface (RFFE) 443/(e.g., 5G NR) decode (block 444), to the packet-level satcom encoded (block 445)/RFFE 446 satellite uplink. In the satellite downlink direction, the L1-PHY transcoder conversion module 335 performs packet-level satcom-to-RFFE 453 decode operations (block 454) to 5G NR encoded (block 456)/RFFE 457 user equipment downlink packets. As shown in FIG. 3, one or more antennas A couple the transcoder device 330 to the user equipment 332 and the NTN satellite 334, which may be via a metasurface (also referred to as a reconfigurable intelligent surface, or RIS 450) as described herein.

It should be noted that FIGS. 3 and 4 use the examples of 5G to and from Satcom conversion. Although not explicitly shown in FIGS. 3 and 4, Wi-Fi and ethernet can be similarly converted, and thus it is understood that FIGS. 3 and 4 only described on nonlimiting example for purposes of explanation.

In the uplink direction from the UE, the L1-PHY conversion module 335 of the transcoder device 330 decodes (block 442) the 5G NR terrestrial air-interface down to the native digital packet-level. Then the L1-PHY conversion module 335 reencodes (block 443) the packets into the legacy satcom air-interface protocol. The downlink direction is the inverse, that is, the L1-PHY conversion module 335 decodes (block 446) the satcom protocol to the packet-level, then reencodes (block 447) to the 5G NR air-interface protocol.

An uplink bypass path is also available for D2D 5G NR, e.g., as represented by the uplink input signal being coupled to one input of an uplink multiplexer (UL Mux) 447. Note that although not explicitly shown in FIG. 4, an optional frequency converter in the uplink bypass path may be present and invoked for situations where the user equipment does not support the 5G NR satellite frequency band(s).

Thus, as described herein, the dual-band device includes an uplink multiplexer (UL Mux) 457 that facilitates selecting between which path to take to transmit to the NTN satellite 334, namely the transcoder/conversion state for Satcom, or the D2D state 5G NR. A control signal CTL[0] determines which state is selected, e.g., as determined by a trained system control and switching model controller as described herein, which in one or more example implementations is a trained artificial intelligence (AI) model.

In one implementation, the uplink multiplexer 457 is a 2X1 Mux that selects between the uplink “Satcom” pipeline path or the “D2D 5G NR” path. The uplink multiplexer 457 can be a dumb hardware Mux, physically selecting the uplink path, e.g., with no dynamically switching Mux features on its own.

FIG. 4 also shows that the output of the 2X1 UL Mux 457 feeds the RIS component 450. The RIS component 450 may be programmed or otherwise configured to operate with multiple frequencies from the Mux output.

With respect to 5G decoding and reencoding in the transcoder conversion pipeline path, note that the 3GPP-compliant 5G NR Layer-1 physical interface logic block diagram is published. The following summarizes some features of 5G NR direct-to-device (D2D) operations and concepts with respect to NTN satellites:

$$NTN Mode = 3 GPP Transparent - Mode \\ L 1 - Physical Interface = 3 GPP - compliant Layer - 1 PHY logic blocks \\ Bands = mobile network operator ( MNO ) terrestrial frequency bands \\ Service - Link = direct - to - device mode ( mobile wireless ) air - interface \\ Feeder - Link = repeated , amplified , frequency - converted to NTN Gateway frequency - band air interface \\ Antenna Technology = varies , depends on FR 1 / FR 2 / NTN bands \\ Physical Constraints = mobile wireless operation , physical challenges \\ Interference , Weather , Scintillation , Channel Modeling , Link - Budget Analysis = mobile wireless operation , various challenges \\ Use - Case / Market / Protocol = IoT , NB - IOT , RedCap , 5 G NR \\ Packet - Format / Tunneled - Packet = 3 GPP GTP - Tunnel , IP , UDP , etc .$$

For the air interface, note that satcom (Digital Video Broadcasting (DVB)-Compliant L1-PHY details are published, including a logic block diagram of a DVB-compliant DVB-S2 Layer-1 Physical Interface (L1-PHY). The logic blocks used on the L1-PHY portion of the satcom can be specific to the DVB-standardized satcom protocol; the DVB standards are global standards that have defined the satcom protocol for many years, and many deployed legacy satellites support the early DVB-S standards. Over the years the DVB consortium has moved from the original DVB-S to DVB-S2 to DVB-S2 to the latest DVB-S2X. The following summarizes some features of satcom operation:

$$NTN Mode = satcom , legacy DVB standards \\ L 1 - Physical Interface = satcom DVB protocol L 1 - PHY logic blocks \\ Bands = satcom satellite frequency bands , K , Ku , Ka , Q / V , S , L \\ Service - Link = satcom air - interface \\ Feeder - Link = satcom air - interface \\ Antenna Technology = varies , depends on K , Ku , Ka , Q / V , S , L bands \\ Physical Constraints = mobile and static wireless operation , physical challenges \\ Interference , Weather , Scintillation , Channel Modeling , Link - Budget Analysis = mobile and static wireless operation , various challenges \\ Use - Case / Market / Protocol = satcom L 1 - PHY , satellite broadband providers , military , governments \\ Packet - Format / Tunneled - Packet = satcom , varied packet formats through the years .$$

A comparison of 5G NR and satcom air-interfaces is shown in the Table 2 below summarizing the above features used by the 3GPP terrestrial mobile wireless industry and the satcom satellite industry. The frequency bands are different from one another, and the frequencies are approved through two different standards organizations, 3GPP and DVB. Some satcom bands have been used for satellite communication for over twenty years, while 3GPP 5G NR bands were allocated around approximately 2015.

TABLE 2

| | satcom | 3GPP 5G NR D2D |
|---|---|---|
| L1-PHY | DVB-S/S2/S2X | 3GPP 5G NR L1 PHY |
| Air Interface | satcom DVB-S/S2/S2X | 3GPP Rel19 5G NR |
| Freq Bands | Bands K, Ku, Ka, Q, V, | FR1/FR2/NTN MNO bands |
| | S, L (WRC allocated) | approved by 3GPP and WRC |
| Market | Mobile wireless, VSAT | Direct-to-Device (D2D), |
| | Broadband, fixed- | UE talks directly to |
| | satellite serves | satellite, IoT/NB-IOT, |
| | (FSS), IoT/NB-IOT | RedCap, FWA Broadband |
| Use Case | Broadband, disaster- | Personal cell, notebook, |
| | relief, emergency | any UE |
| | comms, | |
| Users | VSAT, govt, military, | Mobile wireless |
| | broadband customers, | subscribers/Mobile Network |
| | | Operator (MNO) |
| Satellite Era | Legacy and new satellites | NA |
| (legacy/new) | | |
| Constellations | STARLINK, KUIPER, | NA (limited support for |
| | ONEWEB, DISH/ | 3GPP transparent- |
| | HUGHES/ECHOSTAR, | mode, no support |
| | SDA, GLOBALSTAR, | for regenerative-mode) |
| | IRIDIUM, AST, | |
| | ATT, TELESAT, etc. | |
| Terrestrial | NA | 5G NR |
| Network | | |

As described herein, the transcoder device 330 can be integrated with reconfigurable intelligent surface (RIS) technology to relay the satellite downlink signal into the indoor environment, and vice-versa to relay the indoor UE signal-to-satellite uplink. This removes the constraints of line-of-sight (LoS) between the UE and satellite.

Returning to FIG. 3, metasurface or RIS conversion, represented by block 336, is included for both the UE-side and the satellite-side. A metasurface, or RIS can be used to convert the downlink signal received from the satellite 334 for redirection to the UE 332 by including a frequency converter in between and boosting the signal amplitude, which can be, at least in part, by passive array gain. The metasurface can be similarly used with the uplink signal received from the UE 332 for redirection to the satellite 334. This conversion is not limited to amplitude, but can also include phase change, signal leveling, distortion compensation, up conversion, down conversion, and/or the like, by integrating radio frequency integrated circuit (RFIC) circuitry with the RIS conversion 336 functionality.

With respect to satellite and user equipment frequencies, terrestrial and non-terrestrial networks use different frequency bands, without any sharing therebetween, resulting in issues in the merging of terrestrial and non-terrestrial networks when it comes to frequency bands and air-interfaces. One challenge is that, when using mobile network operator frequency bands or satellite (satcom) frequency bands, there are significant band-rights regulation issues.

The following table 3 shows some satcom and terrestrial frequency bands:

TABLE 3

| | Service-Link | |
|---|---|---|
| Frequency Bands | Uplink | Downlink |
| Terrestrial (5G NR) Bands | FR1 (Sub-6 GHz) | FR1 (Sub-6 GHz) |
| Mobile Network Operator (MNO) | FR2 (mmWave) | FR2 (mmWave) |
| Satcom Bands | L-Band | L-Band |
| | S-Band | S-Band |
| | Ku-Band | Ku-Band |
| | K-Band | K-Band |
| | Ka-Band | Ka-Band |
| | Q/V -Bands | Q/V -Bands |

Frequency conversion is thus needed for the transcoding, and as described herein block 337 represents converting between the 3GPP air-interface and the satcom air-interface frequencies. As is understood, this includes mobile network operators (e.g., 5G)-to-satcom frequency (band) conversion, and satcom-to-mobile network operator frequency (band) conversion. In general, frequency conversion at satellite frequencies is well understood and not described in detail herein, except to reiterate that the frequency conversion of block 337 includes satcom-to-5G and 5G-to-satcom frequency conversion.

A repeater (block 338) can perform other functions, such as including, but not limited to, re-clocking, amplification, and power level adjustment, and can be based on a generic transponder/frequency converter, where in general, a transponder is a broadband RF channel used to amplify one or more carriers on the downlink side of a geostationary communications satellite. A transponder is simply a repeater that takes in the signal from the uplink at one frequency, amplifies the signal and sends it back on another frequency. Satellites can have bent-pipe repeaters, which receive signals in the uplink beam, block translates them to the downlink band, and separates them into individual transponders of a fixed bandwidth. A transponder can be amplified by a traveling wave tube amplifier (TWTA) or a solid state power amplifier (SSPA).

Frequency equalization and negative-slope compensation are incorporated into block 339 of FIG. 3. One of the features of the transcoder device 330 is to equalize the frequency and create a negative image of the loss generated from the conversion, and superimpose it into an equalizer to maintain constant loss over the band. A negative slope compensation technique can be a purely passive resistor network-based technique that can be implemented in the RF chain; the equalization can be hardware-based, software-based, or a combination of both.

Another module/component shown in FIG. 3 is directed towards three-dimensional (3D) doppler shifting/correction/compensation, wherein the Doppler effect (also known as Doppler shift) is the change in the frequency of a wave from the perspective of an observer when the source of the wave and the observer are moving relative to one other. Doppler manipulation (block 340) compensates for the movement as the satellite flies overhead. To this end, the doppler manipulation 340 adjusts based on tracking the changing x-y-z dimensions of the satellite (and the observer RIS, if moving, such as in a vehicle or drone). In this way, for example, the L1-PHY transcoder device 330 can deliver hardware-based doppler-modification data to allow commercially available 5G NR modems (UEs) to communicate better with satcom satellites without any UE modifications.

To summarize, FIGS. 3 and 4 are directed to 5G NR-enabled device uplink transmission, from left-to-right, and satellite downlink transmission, from right to left. The 5G NR-enabled device 332 (e.g., a notebook or smartphone) transmits an RF uplink signal, e.g., using a commercially available 5G NR-enabled components and antenna, e.g., integrated into the device. The RF uplink signal is fed into the L1-PHY transcoder box 335 for processing, and in this particular example, to the 5G NR RF front end component 443, or sent to the Mux 447 via the bypass path.

For Satcom conversion, the 5G NR RF front end component 441 thus receives the RF uplink signal from the user equipment 332 and processes the signal. The front-end handling can include initial filtering, amplification, and/or frequency conversion used for further processing. For decoding to the packet level, the processed RF signal is decoded down to the packet level using 5G NR logic blocks. This can include equalization, demodulation and/or forward-error-correction decoding to extract the data packets from the RF signal. Packet-level transcoding operates via packet conversion, in which the decoded 5G NR packets are converted to Satcom packets. This ensures that the data can be accurately and efficiently transmitted over the satellite communication uplink. In one example implementation, Satcom encoding is based on reencoding the packets using Digital Video Broadcasting (DVB)-compliant Satcom layer-1 protocols. This involves preparing the data for transmission over satellite networks, which can include modulation and forward-error-correction encoding tailored to the DVB Satcom requirements.

The encoded signal is passed through the Satcom RF front end, where it is prepared for RF output/transmission. This can include initial filtering, amplification, and/or frequency conversion to match the satellite uplink requirements. The RF uplink output is then transmitted via the uplink Mux 447 (when selected for conversion) through the RIS component(s) 450 to the NTN satellite 334.

It should be noted that the control signal or the like can also be used to fully bypass the transcoder conversion and thus save compute and power resources. Thus, although the uplink paths in FIG. 4 that are input to the Mux 457 are shown as operating in parallel, this is only one example implementation.

The downlink (receive/RF downlink in) process with respect to reception by the 5G NR-enabled device 332 of the NTN satellite downlink communication signal is shown in the opposite direction in FIG. 4. In general, The NTN satellite 334 transmits an RF downlink (DL) signal, which is received by the RIS component(s) 450. In turn, the RIS component(s) 450 forwards the received signal to the transcoder device with bypass 335 (FIG. 3), and in this example, to the Satcom RF front end component 453 and a D2D 5G NR RF bypass path. Again, while this is shown in parallel in FIG. 4, there can be a selection of one downlink path or the other.

When Satcom-to 5G conversion is needed, the RF downlink signal, which enters the Satcom RF front-end component 453, initially processes the downlink signal, which can include filtering and amplification. The processed RF signal is then decoded (block 454) down to the packet level using DVB logic blocks. This can include equalization, demodulation and forward-error-correction decoding to extract the data packets from the RF signal.

Packet-level transcoding of the downlink signal also operates via packet conversion, that is, the decoded Satcom packets are converted to 5G NR packets. This ensures the data can be accurately and efficiently transmitted over the 5G NR communication link. In general, as shown in FIG. 4, the decoded downlink packets are reencoded (block 455) using 5G NR specific L1-PHY protocols. This involves preparing the data for transmission over the 5G NR network, which can include modulation and forward-error-correction tailored to 5G NR requirements.

The reencoded downlink signal is passed through the 5G NR RF front end component 456, where it is prepared for transmission back to the user equipment 332. This can include filtering, amplification, and/or frequency conversion to match the terrestrial 5G NR downlink requirements. The prepared 5G NR RF downlink output signal is then transmitted, via a downlink Mux 447 (when conversion is selected) back to the user equipment 332 (e.g., a notebook or smartphone).

As with uplink, a downlink (DL) bypass path is also available for D2D 5G NR, e.g., as represented by the downlink input signal being coupled to the other input of the downlink Mux 447 component (block 456). This path can handle any needed frequency conversion, including that the D2D 5G NR bypass path may convert to a different frequency than the original “Satcom-to-5G NR” pipeline. For example, an optional frequency converter in the downlink bypass path (not explicitly shown) may be invoked for situations where the user equipment does not support the 5G NR satellite frequency band(s).

As described herein, the dual-band device includes the downlink multiplexer (DL Mux) 457 that facilitates selecting between which path to take to transmit to the user equipment, namely the transcoder/conversion state for Satcom, or the D2D state 5F NR. A control signal CTL[0] as described herein determines which state is selected. FIG. 4 also shows that the output of the 2X1 Mux 457 is transmitted to the user equipment 332.

In one implementation, the downlink multiplexer 457 is a 2X1 Mux that selects between the downlink “Satcom” pipeline path or the “D2D 5G NR” path. The downlink multiplexer 457 can be a dumb hardware Mux, physically selecting the downlink path, e.g., with no dynamically switching Mux features. Again, for downlink bypass, the entire downlink Satcom conversion path can be bypassed rather than processed in parallel as in FIG. 4.

Turning to controlling the uplink and downlink multiplexer states, in one or more example implementations, the edge compute device 341 runs a number of software modules, including a MUX switching controller 462, the metasurface controller 118, which, among its operations, can also control subdividing of the metasurface for different communication purposes. The edge compute device 341 also can run the network stack 110 of FIG. 1, and so on.

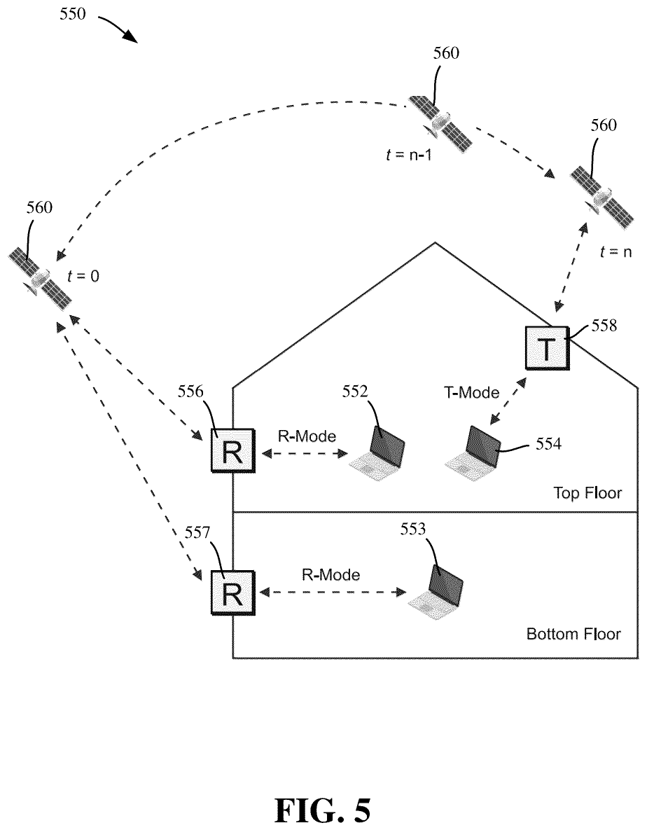

Turning to the use of metasurfaces, FIG. 5 is a representation of an example environment 550 including user equipment 552-554 operating indoors, and metasurfaces 556-558. As described herein, the metasurfaces 556-558 are used to offer signal boost in the 3GPP standardized non-terrestrial network frequency bands as well as possibly the terrestrial network frequency bands used by the user equipment 552-554.

In general, a metasurface (sometimes referred to as a reconfigurable intelligent surface, or RIS) of unit cells is deployed between a satellite and a user equipment (UE). The metasurface can be configured to act as a passive signal gain booster to provide a reliably connected non-terrestrial network service, including in indoor UE scenarios. There is significant signal attenuation experienced by non-terrestrial network services with respect to penetrating indoor environments. Such variability in attenuation, influenced by construction materials and their moisture content, impedes the reliability and performance of direct-to-device connections. This attenuation can range from minimal to severe, ranging from 3 dB (50%) to virtually complete attenuation; for example, metal roofing and attics equipped with radiant barriers present the most challenging conditions, exhibiting signal losses up to 30 dB (99.9% reduction).

To counteract such signal attenuation challenges, the integration of metasurface technology as described herein facilitates non-terrestrial network direct-to-everything service reliability, by using a (for example portable) designed metasurface to boost the attenuated RF signals to and from a satellite, to ensure an end-to-end link supporting always-on connectivity. In general, metasurfaces are surfaces engineered to manipulate electromagnetic waves, offering a pathway to enhance signal strength in either reflection or transmission modes. A metasurface such as described herein can be designed in a way that reduces the fabrication costs exponentially relative to other technologies, as in general a metasurface only needs a single layer of metallization on a substrate. The metasurface can be used for direct-to-everything (DTX) communications, including with smartphones, laptops, automotive vehicles, IoT devices, or inter-device communication, as long as the operating RF frequency is within the gain band of specially designed metasurface.

One implementation of the technology described herein includes a passive (no power needed) metasurface that can be reconfigured into reflection mode or transmission mode by simply attaching or removing a metallic backplane to or from the metasurface. More particularly, a passive metasurface signal booster does not require power to function, and the reconfiguration to the reflection mode can be achieved by attaching a metallic back plane panel to the underside of the metasurface, or removing the back plane to achieve transmission mode. These designs add additional benefits to ensure non-terrestrial network connectivity even during a power outage, which is significant for the safety and emergency response community.

In one implementation, the metasurface can be sufficiently small in size so as to be portable, which can be carried when traveling or moved within a building as needed to enhance the signal strength with respect to non-terrestrial network uplink and downlink communications. The portability of the metasurface allows a user to test out multiple candidate positions, using either a transmission mode or a reflection mode of the metasurface within the targeted indoor environment. In this way, the user knows ahead of time that the non-terrestrial network service is not limited to a single spot. This significantly increases the convenience for the user; for example, in a scenario where the roofing material of a target building only has a few dB of attenuation at non-terrestrial network service link frequency, the metasurface booster gain operating in the transmission mode is adequate to compensate for that small loss. This removes the line-of-sight requirement between the user equipment and the satellite field of view. In general, a user can sit anywhere in a room with boosted non-terrestrial network signal through the transmission mode of a suitably placed portable metasurface, which further enhance the flexibility of the non-terrestrial network service.

In general, a satellite is always in the (low attenuation) field-of-view of a metasurface with respect to the non-terrestrial network (NTN) frequency bands; before one NTN communications satellite travels out of the field of view, another one moves in. Although only a single satellite 560 is depicted in FIG. 5 (at different times t=0, t=n−1 and 1=n), it is understood that at least one satellite is typically always within the field of view of any of the metasurfaces 556-558.

In FIG. 5, the two reflecting mode (“R”) metasurfaces 556 and 557 and one transmission mode (“T”) metasurface 558 provide satellite communication signals to and from user equipment, e.g., laptop or notebook computers 552-554. Note that instead of multiple UE computers 552-554, a single computer can be moved among the various coverage locations of the metasurfaces 556-558.

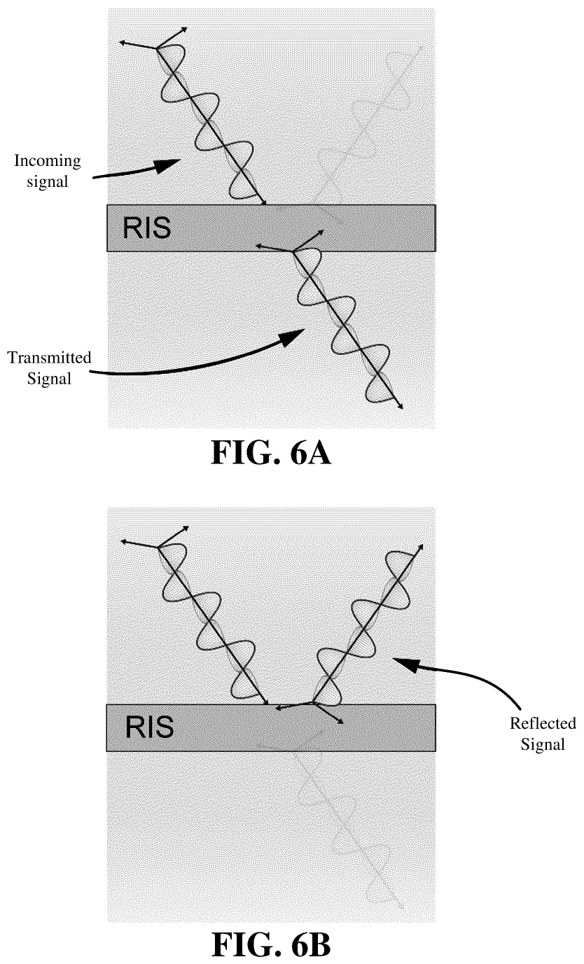

FIGS. 6A and 6B illustrate how an electromagnetic (EM) wave can be redirected by a reflective intelligent surface (RIS), through transmission or reflection, that is, FIGS. 6A and 6B show the concept of a metasurface (reconfigurable intelligent surface, or RIS) in transmission and reflection modes, respectively. As can be seen, in the transmission mode of FIG. 6A, the RIS is basically transparent to the incoming signal, and as described herein (and not explicitly shown in FIG. 6A), respective unit cells of the RIS can be designed with different phase shifts so as to passively refract respective portions of the incoming signals and thereby boost the incoming signal via constructive interference (gain array) of the different refracted respective portions of the incoming waves as refracted by the respective unit cells. Similarly, in the reflection mode of FIG. 6B, the RIS basically reflects a very large percentage of the incoming signal, and as described herein, the respective unit cells of the RIS can be designed with different respective phase shifts so as to passively reflect respective portions and boost via gain array the incoming signal via constructive interference of the different reflected respective portions of the incoming waves as reflected by the respective unit cells.

The range of signal attenuation (e.g., in dB/inch) is different for various commonly used building materials such as plywood, clear glass, cinder block, drywall, and ceiling tile; each material's attenuation properties change with frequency. These building materials have lower attenuation (non-negligible) at lower frequencies, however as expected, the attenuation increases as the frequency rises, which indicates that higher frequencies face greater attenuation, which is a challenge for direct-to-device services that operate at these frequencies. However, the metasurfaces 556-558 in FIG. 1 are positioned to mitigate the attenuation issue, e.g., the two reflecting mode (“R”) metasurfaces 552 and 553 can be placed by windows or behind other low-attenuation materials, while the transmitting mode metasurface 104 can be placed near the ceiling or in line with a skylight so as to have a reasonable line-of-sight connection (i.e., low attenuation conditions) with any position of any satellite in each metasurface's field of view.

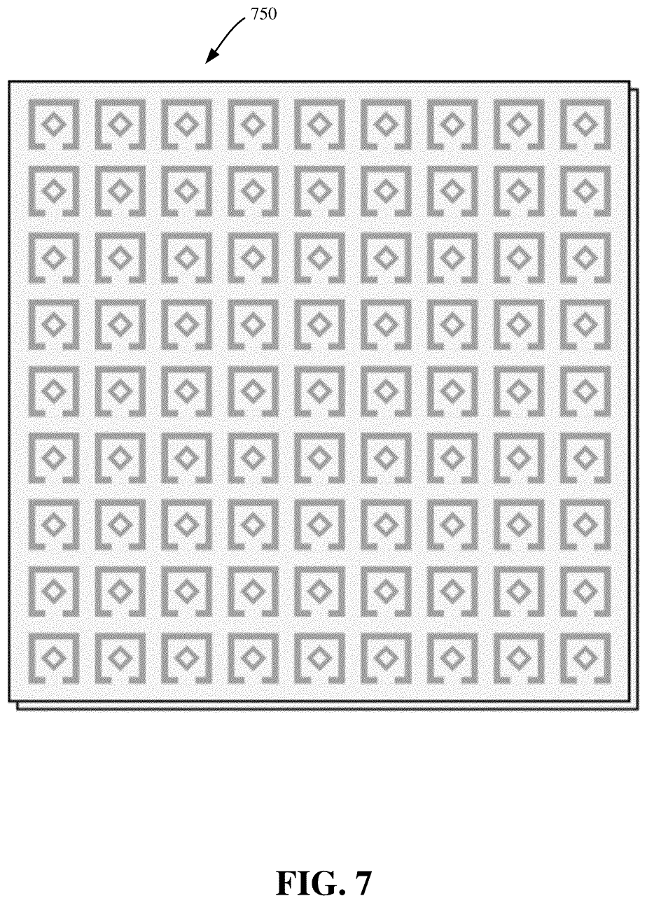

Turning to addition details of the metasurface (RIS), FIG. 7 shows the concept of a metasurface 750 of unit cells. Although not explicitly represented in FIG. 7, one such metasurface can be portable, and can have a metal back plane (e.g., a solid metal sheet) selectively (e.g., manually) attached for reflection mode (R-mode) or detached, whereby the panel works in transmission mode (T-mode). Thus, in one implementation, a complete panel (which can be portable) can include two physical sections; one section is the array of metasurface unit cells (FIG. 7) patterned on a metal layer formed on the dielectric substrate, while the second is a detachable/attachable solid metal sheet that functions as a back plane. When the metal panel is attached to the back of the metasurface array, the metasurface 750 inherently operates in the reflection mode, bouncing the enhanced signals back in the reflecting direction, allowing signals to be reflected from the panel with improved signal strength due to array gain from constructive interference, resulting from different configured phase shifts of the unit cells. When the metasurface is used without the back plane, it operates in a transmission mode, allowing signals to pass through the panel with improved signal strength due to array gain from constructive interference, via refraction of the signal. In one design implementation, a magnetic attachment system can be used to couple the back plane to the underside of the unit cell surface, which simplifies the alignment when transitioning between transmissive and reflective operating modes. By simply placing or removing the back plane, a user can switch the metasurface between its two modes of operation, making the system highly adaptable for different communication scenarios.

In one or more example implementations, a passive portable metasurface can be manually configured to operate either in reflection mode (R-Mode) or in transmission mode (T-mode) to service various device(s)/UE(s). Such portable metasurfaces can be designed in a way to offer signal boost in the 3GPP standardized non-terrestrial network bands without requiring any power source, providing indoor usage scenarios as well as a travel-ready solution for remote areas, and/or during emergency situations when power is not available. It should be noted that while such an inexpensive back plane option allows straightforward reconfiguration of the operating modes of a metasurface, this is a non-limiting example. For example, one user may want a ceiling-mounted metasurface for operating only in the transmission mode, and can thus purchase one without a back plane. In contrast, a different user may want a window-mounted backplane for operating only in the reflection mode, and can purchase a metasurface with a fixed (non-detachable) back plane for presumably less cost than a metasurface with a selectively detachable back plane.

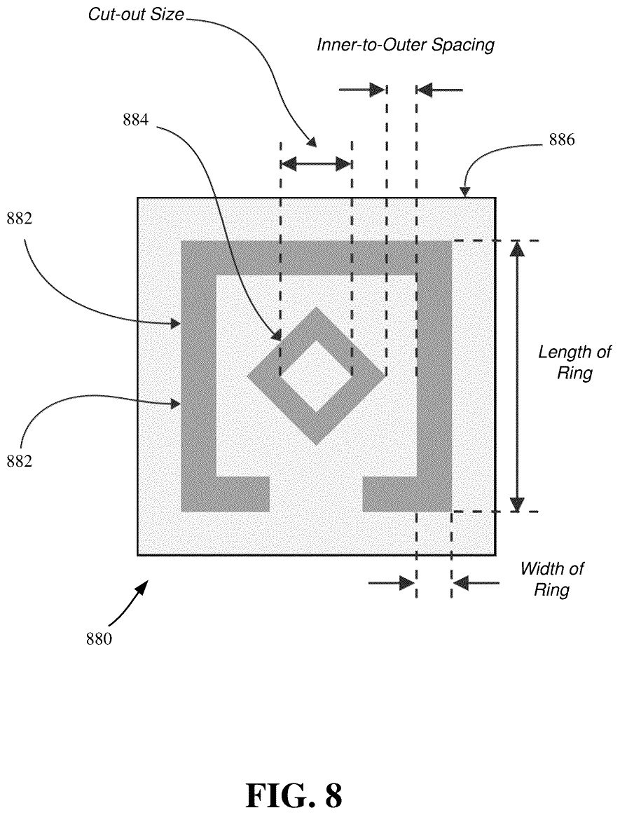

FIG. 8 shows one example design of a unit cell 880 of a metasurface. In this example, the unit cell 880 has a metallic resonating pattern shaped as square split ring (outer shape 882) with a central rhombus (inner shape 884). The pattern is formed from a thin metal film on a dielectric substrate 886. The dimensions of the unit cell 880 determine the frequency at which the unit cell resonates, and are thus sized based on the frequency band of the incoming signal, e.g., the n255 or n256 satellite bands. Smaller dimensions can be used for higher frequencies, such as millimeter wave/FR2 frequencies. Note that FIG. 8 is only one non-limiting example, and that the metallic resonator pattern of a unit cell can be of any shape and size as long as the metallic resonator pattern resonates at the desired frequency.

Scaling of the rhombus shape, or by rotating the inner shape 884, allows the phase of the unit-cell to be tweaked; in this way, a metasurface's unit cells can be coded as per the phase-codebook of the metasurfaces for beam redirection, given an incoming signal from a known general direction relative to the metasurface, e.g., from the sky for a satellite. Various design dimensions are shown in FIG. 8 to better illustrate the optimization variables. This shape of the unit-cell can be developed on any choice of commonly available dielectrics including but not limited to FR4 laminates, Rogers RF substrates, alumina, sapphire, glass, ceramics, or other non-metallic substrates, as long as the unit-cell shows a resonance peak at the desired frequency.

In sum, the technology described herein facilitates a multipath L1-PHY transcoder device (box), which can be a low-cost, low-intelligence (hardware solution, no additional software), for straightforward configuration and operation. The L1-PHY transcoder can be separated from the RIS components to again lower-the cost/complexity. This device can be implemented as a small, light box, which can be implemented in a physical footprint/form factor as small as the size of a cellphone, for example.

In general, for Satcom communications, a packet-level transcoding methodology decodes signals down to the packet-level using 3GPP 5G NR logic blocks before re-encoding them for DVB satellite satcom communication (and vice versa), ensuring high fidelity and minimal data loss. This approach maintains the integrity of the data while allowing efficient transcoding between different communication protocols. Bypass is available for 5G-direct-to-device communications, in both uplink and downlink directions. The L1-PHY device can include additional included features, such as (but not limited) doppler shifting/correction/compensation, frequency up/down converter, modulator/demodulator, frequency equalization, negative-slope compensation, repeater, re-clocking, amplification, power levels, and so on. Note that the doppler compensation technique can be hardware-based/physical doppler-shift compensation that dynamically corrects doppler as the satellite moves across the horizon; this needs no modification to the UE. Frequency conversion can include mobile network operator (MNO)-to-Satcom frequency (band) conversion and Satcom-to-MNO frequency (band) conversion.

The RIS provides the LOS connectivity to the satellites, and also facilitates portability and disaggregation. The indoor RF signal is converted using the transcoding technology described herein, and then uses the RIS to achieve line-of-sight connectivity directly to the satellite. The RIS technology provides the capability to transmit the RF signal outdoor to the indoor environment and transmit UE signal from indoor to outdoor wirelessly, eliminating the needs of a physical cable connecting outdoor antenna and indoor UEs, which adds the benefit of portability.

One or more embodiments and concepts described herein can be embodied in a system, such as described and represented in the drawing figures herein. The system can include a metasurface, and a transcoder device coupled to the metasurface. The transcoder device can include a group of respective network interfaces that can include a satellite interface and a network interface subgroup that can include at least one terrestrial interface. The group of respective network interfaces can be coupled to a network stack that can include a multipath transmission control protocol (MPTCP) library. The MPTCP library can be configured to determine transport connection data representative of one or more selected data paths from among respective available MPTCP subflows corresponding to the respective network interfaces of the group of network interfaces. The system can include a metasurface controller coupled to the network stack, the metasurface controller obtaining the transport connection data from the network stack, and adjusting property data of the metasurface based on the transport connection data. The transcoder device can obtain network data and can output the network data to the network stack for transmission to a receiving device via the one or more selected data paths.

At least one of the one or more selected data paths can be coupled to the receiving device via the metasurface.

A first data path of the one or more selected data paths, and a second data path of the one or more selected data paths, can be coupled to the receiving device via the metasurface. The metasurface can be subdivided into a first portion for transmission of first network data obtained via the first data path, and a second portion for transmission of second network data obtained via the second data path.

The network interface subgroup can include at least one of: an ethernet interface, a wireless fidelity interface, or a new radio interface.

The metasurface controller configures the metasurface based on the transport connection data and current network conditions.

The metasurface can return signal quality feedback data to the MPTCP library via the metasurface controller, and the MPTCP library can adjust the transport connection data based on the signal quality feedback data for subsequent network data transmission.

The satellite interface can include a satellite interface transceiver, and the network interface subgroup group can include at least one terrestrial interface transceiver.

The group of respective network interfaces can include respective transceivers.

The MPTCP library can be integrated into the network stack.

The network stack can return the transport connection data to a source device from which the network stack obtains the network data.

The network data can include terrestrial data obtained from a user equipment, the receiving device can include a satellite, the one or more selected data paths can include a user equipment-to-satellite data path, and the transcoder device can convert the terrestrial data to non-terrestrial data for transmission to the satellite.

The network data can include non-terrestrial data obtained from a satellite, the receiving device can include a user equipment, the one or more selected data paths can include a satellite-to-user equipment data path, and the transcoder device can convert the non-terrestrial data to terrestrial data for transmission to the user equipment.

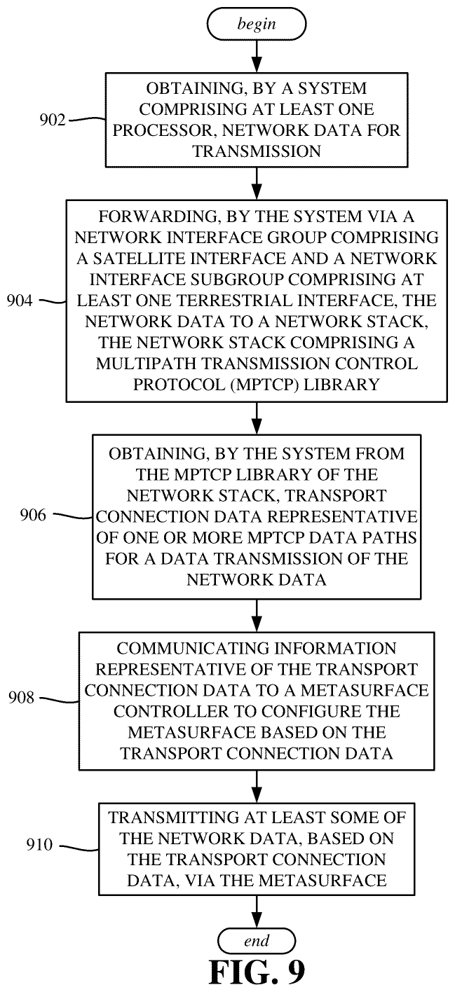

One or more example implementations and embodiments, such as corresponding to example operations of a method, or computer executable instructions/components can be represented in FIG. 9. Example operation 902 represents obtaining, by a system comprising at least one processor, network data for transmission. Example operation 904 represents forwarding, by the system via a network interface group comprising a satellite interface and a network interface subgroup comprising at least one terrestrial interface, the network data to a network stack, the network stack comprising a multipath transmission control protocol (MPTCP) library. Example operation 906 represents obtaining, by the system from the MPTCP library of the network stack, transport connection data representative of one or more MPTCP data paths for a data transmission of the network data. Example operation 908 represents communicating information representative of the transport connection data to a metasurface controller to configure the metasurface based on the transport connection data. Example operation 910 represents transmitting at least some of the network data, based on the transport connection data, via the metasurface.

The transport connection data can be first transport connection data, and the metasurface can return signal quality feedback data to the network stack; further operations can include, adjusting, by the MPTCP library of the system based on the signal quality feedback data, the first transport connection data to second transport connection data that can be different from the first transport connection data.

The transport connection data can identify a first MPTCP data path and a second MPTCP data path; further operations can include subdividing the metasurface into a first portion for transmitting data corresponding to the first MPTCP path, and a second portion for transmitting data corresponding to the second MPTCP path.

The network data can include terrestrial new radio data, the transport connection data can represent an MPTCP path to a satellite; further operations can include transcoding, by the system, the terrestrial new radio data to non-terrestrial satellite communications (Satcom) data for transmission to the satellite.

The network data can include non-terrestrial satellite communications (Satcom) data, the transport connection data can represent an MPTCP path from a satellite; further operations can include transcoding, by the system, the non-terrestrial Satcom data to terrestrial new radio data for transmission to terrestrial new radio user equipment.

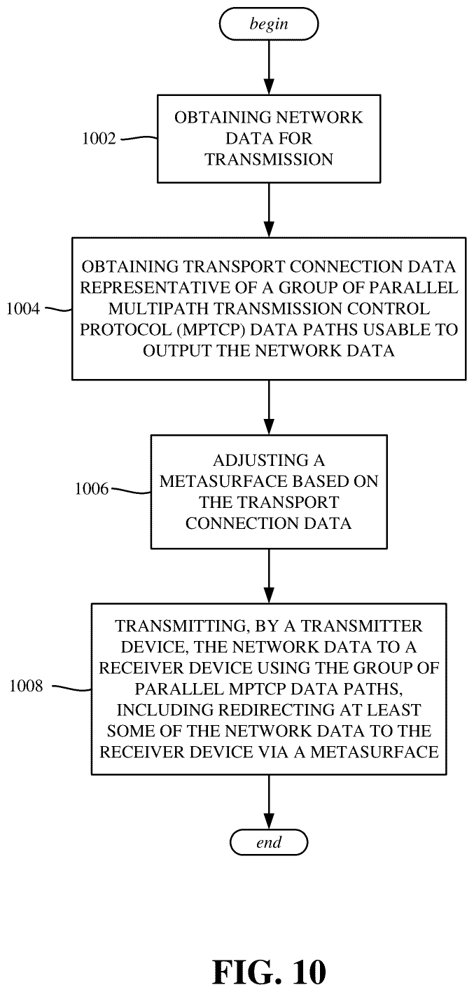

One or more example embodiments, such as corresponding to example operations of a method, system and/or machine readable medium of executable instructions executable by at least one processor, can be represented in FIG. 10. Example operation 1002 represents obtaining network data for transmission. Example operation 1004 represents obtaining transport connection data representative of a group of parallel multipath transmission control protocol (MPTCP) data paths usable to output the network data. Example operation 1006 represents adjusting a metasurface based on the transport connection data. Example operation 1008 represents transmitting, by a transmitter device, the network data to a receiver device using the group of parallel MPTCP data paths, comprising redirecting at least some of the network data to the receiver device via a metasurface.

The network data can be first network data, the transport connection data can be first transport connection data of a first group of parallel MPTCP data paths, and further example operations can include returning signal quality feedback data to the transmitting device, obtaining second network data for transmission, obtaining second transport connection data representative of a second group of parallel MPTCP data paths, adjusting the metasurface based on the second transport connection data, and transmitting, by the transmitter device, the second network data to the receiver device using the second group of parallel MPTCP data paths, comprising redirecting at least some of the second network data to the receiver device via a metasurface.

One data path of the group of parallel MPTCP data paths can include a satellite interface for data transmission to a satellite configured for satellite communication (Satcom) data, and further example operations can include, prior to the transmitting of the network data to the receiver device using the data path comprising the satellite interface, converting terrestrial packet data of the network data to non-terrestrial Satcom packet data.

As can be seen, the technology described herein includes advanced multipath routing techniques to enhance redundancy, load balancing, and overall network reliability. By distributing data across multiple communication paths, such as in a single portable transcoder device/box structure, the system ensures virtually continuous connectivity and optimal performance, even in the presence of network failures or varying signal conditions.

Satellite connection and communication can be based on L1-PHY transcoder technology and metasurface (RIS) technology, in which the transcoder converts between the Satcom-air-interface and the 3GPP-5G-NR-air-interface, including decoding and reencoding data packets at the L1-PHY packet level, or operates in a bypass mode for D2D communications. A controller controls uplink and downlink multiplexer states to select between the transcoder conversion mode or the bypass mode. This device can be implemented in an L1-PHY appliance (the transcoder box structure) that allows a 3GPP-compliant 5G NR model to connect directly to legacy and future LEO satellite constellations.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a metasurface; and
a transcoder device coupled to the metasurface, the transcoder device comprising:
a group of respective network interfaces comprising a satellite interface and a network interface subgroup comprising at least one terrestrial interface, the group of respective network interfaces coupled to a network stack comprising a multipath transmission control protocol (MPTCP) library, the MPTCP library configured to determine transport connection data representative of one or more selected data paths from among respective available MPTCP subflows corresponding to the respective network interfaces of the group of network interfaces, and
a metasurface controller coupled to the network stack, the metasurface controller obtaining the transport connection data from the network stack, and adjusting property data of the metasurface based on the transport connection data,
wherein the transcoder device obtains network data and outputs the network data to the network stack for transmission to a receiving device via the one or more selected data paths.

2. The system of claim 1, wherein at least one of the one or more selected data paths is coupled to the receiving device via the metasurface.

3. The system of claim 1, wherein a first data path of the one or more selected data paths, and a second data path of the one or more selected data paths, are coupled to the receiving device via the metasurface, and wherein the metasurface is subdivided into a first portion for transmission of first network data obtained via the first data path, and a second portion for transmission of second network data obtained via the second data path.

4. The system of claim 1, wherein the network interface subgroup comprises at least one of: an ethernet interface, a wireless fidelity interface, or a new radio interface.

5. The system of claim 1, wherein the metasurface controller configures the metasurface based on the transport connection data and current network conditions.

6. The system of claim 1, wherein the metasurface returns signal quality feedback data to the MPTCP library via the metasurface controller, and wherein the MPTCP library adjusts the transport connection data based on the signal quality feedback data for subsequent network data transmission.

7. The system of claim 1, wherein the satellite interface comprises a satellite interface transceiver, and wherein the network interface subgroup group comprises at least one terrestrial interface transceiver.

8. The system of claim 1, wherein the group of respective network interfaces comprises respective transceivers.

9. The system of claim 1, wherein the MPTCP library is integrated into the network stack.

10. The system of claim 1, wherein the network stack returns the transport connection data to a source device from which the network stack obtains the network data.

11. The system of claim 1, wherein the network data comprises terrestrial data obtained from a user equipment, wherein the receiving device comprises a satellite, wherein the one or more selected data paths comprise a user equipment-to-satellite data path, and wherein the transcoder device converts the terrestrial data to non-terrestrial data for transmission to the satellite.

12. The system of claim 1, wherein the network data comprises non-terrestrial data obtained from a satellite, wherein the receiving device comprises a user equipment, wherein the one or more selected data paths comprise a satellite-to-user equipment data path, and wherein the transcoder device converts the non-terrestrial data to terrestrial data for transmission to the user equipment.

13. A method, comprising:
obtaining, by a system comprising at least one processor, network data for transmission;
forwarding, by the system via a network interface group comprising a satellite interface and a network interface subgroup comprising at least one terrestrial interface, the network data to a network stack, the network stack comprising a multipath transmission control protocol (MPTCP) library;
obtaining, by the system from the MPTCP library of the network stack, transport connection data representative of one or more MPTCP data paths for a data transmission of the network data;
communicating information representative of the transport connection data to a metasurface controller to configure the metasurface based on the transport connection data; and
transmitting at least some of the network data, based on the transport connection data, via the metasurface.

14. The method of claim 13, wherein the transport connection data is first transport connection data, wherein the metasurface returns signal quality feedback data to the network stack, and further comprising, adjusting, by the MPTCP library of the system based on the signal quality feedback data, the first transport connection data to second transport connection data that is different from the first transport connection data.

15. The method of claim 13, wherein the transport connection data identifies a first MPTCP data path and a second MPTCP data path, and further comprising subdividing the metasurface into a first portion for transmitting data corresponding to the first MPTCP path, and a second portion for transmitting data corresponding to the second MPTCP path.

16. The method of claim 13, wherein the network data comprises terrestrial new radio data, wherein the transport connection data represents an MPTCP path to a satellite, and further comprising transcoding, by the system, the terrestrial new radio data to non-terrestrial satellite communications (Satcom) data for transmission to the satellite.

17. The method of claim 13, wherein the network data comprises non-terrestrial satellite communications (Satcom) data, wherein the transport connection data represents an MPTCP path from a satellite, and further comprising transcoding, by the system, the non-terrestrial Satcom data to terrestrial new radio data for transmission to terrestrial new radio user equipment.

18. A non-transitory machine-readable medium, comprising executable instructions that, when executed by at least one processor, facilitate performance of operations, the operations comprising:
obtaining network data for transmission;
obtaining transport connection data representative of a group of parallel multipath transmission control protocol (MPTCP) data paths usable to output the network data;
adjusting a metasurface based on the transport connection data; and
transmitting, by a transmitter device, the network data to a receiver device using the group of parallel MPTCP data paths, comprising redirecting at least some of the network data to the receiver device via a metasurface.

19. The non-transitory machine-readable medium of claim 18, wherein the network data is first network data, wherein the transport connection data is first transport connection data of a first group of parallel MPTCP data paths, and wherein the operations further comprise returning signal quality feedback data to the transmitting device, obtaining second network data for transmission, obtaining second transport connection data representative of a second group of parallel MPTCP data paths, adjusting the metasurface based on the second transport connection data, and transmitting, by the transmitter device, the second network data to the receiver device using the second group of parallel MPTCP data paths, comprising redirecting at least some of the second network data to the receiver device via a metasurface.

20. The non-transitory machine-readable medium of claim 18, wherein one data path of the group of parallel MPTCP data paths comprises a satellite interface for data transmission to a satellite configured for satellite communication (Satcom) data, and wherein the operations further comprise, prior to the transmitting of the network data to the receiver device using the data path comprising the satellite interface, converting terrestrial packet data of the network data to non-terrestrial Satcom packet data.
